(19) United States
(12) Patent Application Publication
(10) Pub. No.: US 2023/0175215 A1
(43) Pub. Date: Jun. 8, 2023

(54) SPIKE BARRIER DETECTION VEHICULAR SYSTEM AND METHOD

(71) Applicant: Continental Automotive GmbH, Hannover (DE)

(72) Inventors: Shashi Kumar Miraskar, Bangalore (IN); Bharath Shivapuram, Bengaluru (IN); Ravi Mugad, Belgaum (IN)

(73) Assignee: Continental Automotive GmbH, Hannover (DE)

(21) Appl. No.: 17/457,568

(22) Filed: Dec. 3, 2021

(51) Int. Cl. E01F 13/12; G06V 20/54; G06V 20/58

(52) U.S. Cl. CPC E01F 13/12; G06V 20/54; G06V 20/58

(57) ABSTRACT

A spike barrier detection vehicular system including an image receiver configured to receive an image having a spike barrier and a vehicular approach prevention direction determiner configured to determine a vehicular approach prevention direction of the spike barrier, based on the image comprising the spike barrier.

### TECHNICAL FIELD

The technical field generally relates to a spike barrier detection vehicular system, and particularly to a spike barrier detection vehicular system for a motor vehicle, and a spike barrier detection vehicular method.

### BACKGROUND

A spike barrier may be used to control motor vehicle movements through an area. For instance, a spike barrier may be placed across a lane at a place, for instance, a checkpoint, to prevent motor vehicles from travelling through the checkpoint from one direction or both directions. A spike barrier may be configured to prevent a motor vehicle from approaching the spike barrier from a first direction, a second direction opposite the first direction or both the first and second directions. Hence, it may be advantageous to determine a vehicular approach prevention direction of a spike barrier.

### SUMMARY

An objective is to provide a method or a system of determining a vehicular approach prevention direction of a spike barrier.

According to a first aspect of the disclosure, there is provided a spike barrier detection vehicular system including: an image receiver configured to receive an image comprising a spike barrier; and a vehicular approach prevention direction determiner configured to determine a vehicular approach prevention direction of the spike barrier, based on the image comprising the spike barrier.

One advantage of the spike barrier detection vehicular system is that it is able to assist in the control of a motor vehicle by determining a vehicular approach prevention direction of a spike barrier, based on the image comprising the spike barrier.

Optionally, the image receiver is configured to receive at least two images from a plurality of imaging devices, each image from a respective imaging device.

One advantage of the spike barrier detection vehicular system is that it may receive images from several sources.

The spike barrier detection vehicular system may further include a vehicular plan image constructor configured to construct a vehicular plan view image comprising the spike barrier based on the image comprising the spike barrier; wherein the vehicular approach prevention direction determiner is configured to determine the vehicular approach prevention direction of the spike barrier, based on the vehicular plan view image comprising the spike barrier.

One advantage of the spike barrier detection vehicular system is that a quick and resource-light system is provided to determine a vehicular approach prevention direction of a spike barrier, based on a vehicular plan view image.

Optionally, the spike barrier comprises at least two vehicular immobility projections; further including a length determiner configured to determine a first average length between the at least two vehicular immobility projections and a first edge of the spike barrier based on the vehicular plan view image comprising the spike barrier and a second average length between the at least two vehicular immobility projections and a second edge of the spike barrier based on the vehicular plan view image comprising the spike barrier; wherein the first average length determined is substantially parallel to the vehicular approach prevention direction and the second average length determined is substantially parallel to the vehicular approach prevention direction.

One advantage of the spike barrier detection vehicular system is that a quick and resource-light system is provided to determine a vehicular approach prevention direction of a spike barrier, based on a vehicular plan view image.

Optionally, the spike barrier includes at least two vehicular immobility projections; further including a length determiner configured to determine a first average length between the at least two vehicular immobility projections and a first edge of the spike barrier and a second average length between the at least two vehicular immobility projections and a second edge of the spike barrier; wherein the first average length determined is substantially parallel to the vehicular approach prevention direction and the second average length determined is substantially parallel to the vehicular approach prevention direction.

One advantage of the spike barrier detection vehicular system is that a quick and resource-light system is provided to determine a vehicular approach prevention direction of a spike barrier.

Optionally, the vehicular approach prevention direction determiner is configured to determine that the vehicular approach prevention direction of the spike barrier is towards the first edge of the spike barrier if the first average length is longer than the second average length and that the vehicular approach prevention direction of the spike barrier is towards the second edge of the spike barrier if the second average length is longer than the first average length.

One advantage of the spike barrier detection vehicular system is that a quick and resource-light system is provided to determine a vehicular approach prevention direction of a spike barrier.

Optionally, each vehicular immobility projection includes a respective converging end configured to puncture a tyre; and wherein the vehicular approach prevention direction determiner is configured to determine that the converging ends are orientated towards the first edge of the spike barrier if the first average length is longer than the second average length and that the converging ends are orientated towards the second edge of the spike barrier if the second average length is longer than the first average length.

One advantage of the spike barrier detection vehicular system is that a quick and resource-light system is provided to determine orientations of converging ends of a spike barrier.

A motor vehicle may include the spike barrier detection vehicular system.

Any feature or step disclosed in the context of the first aspect of the disclosure may also be used, to the extent possible, in combination with and/or in the context of other aspects of the disclosure, and in the disclosure generally. In addition, any feature or step disclosed in the context of any other aspect of the disclosure may also be used, to the extent possible, in combination with and/or in the context of the first aspect of the disclosure, and in the disclosures generally.

According to a second aspect of the disclosure, there is provided a spike barrier detection vehicular system including: an image receiver configured to receive an image comprising a spike barrier, wherein the spike barrier includes at least two vehicular immobility projections; wherein the image receiver is configured to receive at least two images from a plurality of imaging devices, each image from a respective imaging device; a vehicular plan image constructor configured to construct a vehicular plan view image comprising the spike barrier based on the image including the spike barrier; a length determiner configured to determine a first average length between the at least two vehicular immobility projections and a first edge of the spike barrier based on the vehicular plan view image including the spike barrier and a second average length between the at least two vehicular immobility projections and a second edge of the spike barrier based on the vehicular plan view image comprising the spike barrier; wherein the first average length determined is substantially parallel to the vehicular approach prevention direction and the second average length determined is substantially parallel to the vehicular approach prevention direction; and a vehicular approach prevention direction determiner configured to determine a vehicular approach prevention direction of the spike barrier, based on the image including the spike barrier; wherein the vehicular approach prevention direction determiner is configured to determine the vehicular approach prevention direction of the spike barrier, based on the vehicular plan view image comprising the spike barrier; wherein the vehicular approach prevention direction determiner is configured to determine that the vehicular approach prevention direction of the spike barrier is towards the first edge of the spike barrier if the first average length is longer than the second average length and that the vehicular approach prevention direction of the spike barrier is towards the second edge of the spike barrier if the second average length is longer than the first average length; wherein each vehicular immobility projection includes a respective converging end configured to puncture a tyre; and wherein the vehicular approach prevention direction determiner is configured to determine that the converging ends are orientated towards the first edge of the spike barrier if the first average length is longer than the second average length and that the converging ends are orientated towards the second edge of the spike barrier if the second average length is longer than the first average length.

One advantage of the spike barrier detection vehicular system is that it is able to assist in the control of a motor vehicle by determining a vehicular approach prevention direction of a spike barrier, based on the image comprising the spike barrier.

Any feature or step disclosed in the context of the second aspect of the disclosure may also be used, to the extent possible, in combination with and/or in the context of other aspects of the disclosure, and in the disclosures generally. In addition, any feature or step disclosed in the context of any other aspect of the disclosure may also be used, to the extent possible, in combination with and/or in the context of the second aspect of the disclosure, and in the disclosures generally.

According to a third aspect of the disclosure, there is provided a computer-implemented spike barrier detection vehicular method including the acts of: receiving an image comprising a spike barrier; and determining a vehicular approach prevention direction of the spike barrier, based on the image comprising the spike barrier.

One advantage of the spike barrier detection vehicular method is that it is able to assist in the control of a motor vehicle by determining a vehicular approach prevention direction of a spike barrier, based on the image comprising the spike barrier.

The spike barrier detection vehicular method may further include the act of receiving at least two images from a plurality of imaging devices, each image from a respective imaging device.

One advantage of the spike barrier detection vehicular method is that it may receive images from several sources.

The spike barrier detection vehicular method may further includes the act of constructing a vehicular plan view image including the spike barrier based on the image comprising the spike barrier; wherein the act of determining the vehicular approach prevention direction of the spike barrier includes the act of determining the vehicular approach prevention direction of the spike barrier, based on the vehicular plan view image including the spike barrier.

One advantage of the spike barrier detection vehicular method is that a quick and resource-light method is provided to determine a vehicular approach prevention direction of a spike barrier, based on a vehicular plan view image.

Optionally, wherein the act of receiving the image including the spike barrier includes the act of receiving the image comprising the spike barrier wherein the spike barrier includes at least two vehicular immobility projections; further including the acts of: determining a first average length between the at least two vehicular immobility projections and a first edge of the spike barrier based on the vehicular plan view image comprising the spike barrier, wherein the first average length determined is substantially parallel to the vehicular approach prevention direction; and determining a second average length between the at least two vehicular immobility projections and a second edge of the spike barrier based on the vehicular plan view image comprising the spike barrier, wherein the second average length determined is substantially parallel to the vehicular approach prevention direction.

One advantage of the spike barrier detection vehicular method is that a quick and resource-light method is provided to determine a vehicular approach prevention direction of a spike barrier, based on a vehicular plan view image.

Optionally, wherein the act of receiving the image including the spike barrier includes the act of receiving the image comprising the spike barrier wherein the spike barrier comprises at least two vehicular immobility projections; and further including the act of: determining a first average length between the at least two vehicular immobility projections and a first edge of the spike barrier, wherein the first average length determined is substantially parallel to the vehicular approach prevention direction; and determining a second average length between the at least two vehicular immobility projections and a second edge of the spike barrier, wherein the second average length determined is substantially parallel to the vehicular approach prevention direction.

One advantage of the spike barrier detection vehicular method is that a quick and resource-light method is provided to determine a vehicular approach prevention direction of a spike barrier.

Optionally, the act of determining the vehicular approach prevention direction of the spike barrier comprises the act of determining that the vehicular approach prevention direction of the spike barrier is towards the first edge of the spike barrier if the first average length is longer than the second average length and that the vehicular approach prevention direction of the spike barrier is towards the second edge of the spike barrier if the second average length is longer than the first average length.

One advantage of the spike barrier detection vehicular method is that a quick and resource-light method is provided to determine a vehicular approach prevention direction of a spike barrier.

Optionally, wherein the act of receiving the image including the spike barrier includes the act of receiving the image including the spike barrier, wherein each vehicular immobility projection includes a respective converging end configured to puncture a tyre; and wherein the act of determining the vehicular approach prevention direction of the spike barrier comprises the act of determining that the converging ends are orientated towards the first edge of the spike barrier if the first average length is longer than the second average length and that the converging ends are orientated towards the second edge of the spike barrier if the second average length is longer than the first average length.

One advantage of the spike barrier detection vehicular method is that a quick and resource-light method is provided to determine orientations of converging ends of a spike barrier.

Any feature or step disclosed in the context of the third aspect of the disclosure may also be used, to the extent possible, in combination with and/or in the context of other aspects of the disclosure, and in the disclosures generally. In addition, any feature or step disclosed in the context of any other aspect of the disclosure may also be used, to the extent possible, in disclosures with and/or in the context of the third aspect of the disclosure, and in the inventions generally.

As used in this summary, in the description below, in the claims below, and in the accompanying drawings, reference is made to particular features (including method steps) of the disclosure. It is to be understood that the disclosure of the invention in this specification includes all possible combinations of such particular features. For example, where a particular feature is disclosed in the context of a particular aspect or embodiment of the invention, or a particular claim, that feature may also be used, to the extent possible, in combination with and/or in the context of other particular aspects and embodiments of the invention, and in the inventions generally.

As used in this summary, in the description below, in the claims below, and in the accompanying drawings, where reference is made herein to a method including two or more defined steps or acts, the defined steps or acts may be carried out in any order or simultaneously (except where the context excludes that possibility), and the method may include one or more other steps or acts which are carried out before any of the defined steps or acts, between two of the defined steps or acts, or after all the defined steps or acts (except where the context excludes that possibility).

As used in this summary, in the description below, in the claims below, and in the accompanying drawings, the terms “comprises,” “including,” and grammatical equivalents thereof are used herein to mean that other components, ingredients, steps, et cetera are optionally present. For example, an article “comprising” (or “which comprises”) components A, B, and C may consist of (that is, contain only) components A, B, and C, or may contain not only components A B, and C but also one or more other components.

As used in this summary, in the description below, in the claims below, and in the accompanying drawings, the term “at least” followed by a number is used in to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending on the variable being defined). For example, “at most 4” means 4 or less than 4, and “at most 40%” means 40% or less than 40%. When, in this specification, a range is given as “(a first number) to (a second number)” or “(a first number) - (a second number)”, this means a range whose lower limit is the first number and whose upper limit is the second number. For example, 25 to 100 mm means a range whose lower limit is 25 mm, and whose upper limit is 100 mm.

As used in this summary, in the description below, in the claims below, and in the accompanying drawings, the term “vehicle” means a transportation device suitable for transporting humans or goods from a first location to a second location. In addition, a vehicle comprises the transportation device itself, such as a motor vehicle, or a component connected to the vehicle, such as a trailer or a sidecar.

As used in this summary, in the description below, in the claims below, and in the accompanying drawings, the term “motor vehicle” means a road vehicle driven by an engine.

As used in this summary, in the description below, in the claims below, and in the accompanying drawings, the term “image” means a two-dimensional or three-dimensional picture of an actual location in the real world. An image may be captured by one single image capturing device, such as a camera or a LiDAR sensor, or created by fusing data from several devices, such as ultrasonic sensor, LiDAR sensor, radar sensor or camera.

As used in this summary, in the description below, in the claims below, and in the accompanying drawings, the term “vehicular camera” means a camera that is suitable to be used with a vehicle, such as a motor vehicle, a trailer or a sidecar. A vehicular camera may be installed in the interior or exterior of the vehicle, e.g., such as being attached to a rear-view mirror, or be mounted on an exterior portion of the vehicle, such as being affixed to a wing mirror.

As used in this summary, in the description below, in the claims below, and in the accompanying drawings, the term “machine learning system” means a computer system that is able to learn without direct programming instructions. A machine learning system applies statistical modelling to detect patterns and to improve performance, based on data input and without direct programming instructions. A machine learning system builds a statistical model through a training or learning process, which involves inputting data to the machine learning system. The four basic categories of learning process are supervised learning using labelled data sets, unsupervised learning using unlabelled data sets, semi-supervised learning using a mix of labelled data sets and unlabelled data sets, and reinforcement learning that involves learning by trial and error. Decision tree, support vector machine and neural network are examples of types of machine learning system.

As used in this summary, in the description below, in the claims below, and in the accompanying drawings, the term “neural network” or the term “artificial neural network” means a type of machine learning algorithm that uses a web of nodes, edges and layers. The first layer of a neural network comprises input nodes that accept data inputs from a data set. The input nodes then send information through the edges to the nodes in the next layer. Each edge comprises an activation function that is alterable during a training process. The final layer of the neural network comprises the output nodes that provide data outputs of the neural network. During the training process, the data outputs of the neural network are compared to the actual outputs of the data set. The differences between the data outputs of the neural network and the actual outputs of the data set are measured and denoted as an error value. The error value is then fed back to the neural network, which changes its activation functions in order to minimise the error value. The training process is an iterative process. After the neural network has been trained, the trained neural network may then be used to predict a data output from a particular data input. LSTM network is an example of a type of artificial neural network.

As used in this summary, in the description below, in the claims below, and in the accompanying drawings, the term “motor vehicle driver assistance system” means a system configured to help or support a driver or a driving system to drive a vehicle. A motor vehicle driver assistance system may be carried out by software, hardware or a combination of software and hardware.

As used in this summary, in the description below, in the claims below, and in the accompanying drawings, the term “motor vehicle driver assistance method” means a method that is able to help or support a driver or a driving system to drive a vehicle. A motor vehicle driver assistance method may be carried out by software, hardware or a combination of software and hardware.

As used in this summary, in the description below, in the claims below, and in the accompanying drawings, the term “vehicular camera” means a camera that is suitable to be used with a vehicle, such as a motor vehicle, a trailer or a sidecar. A vehicular camera may be installed in the interior of the vehicle, such as being attached to a rear-view mirror, or be mounted on an exterior portion of the vehicle, such as being affixed to a wing mirror.

As used in this summary, in the description below, in the claims below, and in the accompanying drawings, the term “vehicular image” means a picture captured by a vehicular camera.

As used in this summary, in the description below, in the claims below, and in the accompanying drawings, the term “plan view” means a view of an object, such as a vehicle, as though the object is seen from above, albeit not necessarily from directly above, the object. Hence, a plan view includes a view of an object as though the object is seen from above and at a non-zero angle to a vertical axis of the object.

As used in this summary, in the description below, in the claims below, and in the accompanying drawings, the term “plan view image” means a picture captured or generated comprising a view of an object, such as a vehicle, as though the object is seen from above, albeit not necessarily from directly above, the object.

As used in this summary, in the description below, in the claims below, and in the accompanying drawings, the term “vehicular plan view image” means a picture, for instance, generated by a surround view system, comprising a view of an exterior of a vehicle, as though the vehicle is seen from above, albeit not necessarily from directly above, the vehicle and its surroundings. For instance, a vehicular plan image constructor may construct a vehicular plan view image by combining a plurality of vehicular images captured by a plurality of vehicular cameras, wherein each of the plurality of vehicular cameras is directed in a respective different direction outwards from a vehicle in order to capture a corresponding different portion of an environment of the vehicle.

As used in this summary, in the description below, in the claims below, and in the accompanying drawings, the term “pose” means a particular position and orientation. A position may be defined using the commonly used mathematical notations of x axis, y axis and z axis, and an orientation may be expressed in terms of yaw angle, pitch angle and roll angle.

As used in this summary, in the description below, in the claims below, and in the accompanying drawings, the term “scale” and grammatical equivalents thereof are used herein to mean to change the size of an object, for instance in an image. Hence, to “scale” down means to reduce the size of the object, for instance in the image, and to “scale” up means to increase the size of the object.

As used in this summary, in the description below, in the claims below, and in the accompanying drawings, the term “translate” and grammatical equivalents thereof are used herein to mean to move an object, for instance in an image, from a first location, for instance in the image, to a second location, for instance in the image.

As used in this summary, in the description below, in the claims below, and in the accompanying drawings, the term “orientate” and grammatical equivalents thereof are used herein to mean to adapt an object to point in a certain direction. For instance, if a converging end is orientated towards a first edge, the converging end is pointing towards the first edge.

As used in this summary, in the description below, in the claims below, and in the accompanying drawings, the term “spike barrier” means an object or a structure comprising vehicular immobility projections that are designed to prevent a motor vehicle from moving towards the object or the structure in a certain direction, for instance, by puncturing the motor vehicle’s tyres when the motor vehicle rolls over the object or the structure.

As used in this summary, in the description below, in the claims below, and in the accompanying drawings, the term “vehicular immobility projection” means a protruding object or structure that is configured to prevent a motor vehicle from moving, for instance, by puncturing the motor vehicle’s tyres when the motor vehicle rolls over the protruding object or structure.

As used in this summary, in the description below, in the claims below, and in the accompanying drawings, the term “converging end” means a narrowing edge or point.

As used in this summary, in the description below, in the claims below, and in the accompanying drawings, the term “spike barrier detection vehicular system” means a system configured to detect spike barriers, wherein the system is configured to be used by a motor vehicle.

As used in this summary, in the description below, in the claims below, and in the accompanying drawings, the term “spike barrier detection vehicular method” means a method configured to detect spike barriers, wherein the method is configured to be used by a motor vehicle.

As used in this summary, in the description below, in the claims below, and in the accompanying drawings, the term “vehicular approach prevention direction” means a certain direction towards which a spike barrier is configured to impede the progress of a motor vehicle.

As used in this summary, in the description below, in the claims below, and in the accompanying drawings, the term “edge” means a physical periphery limit of an object or an area.

As used in this summary, in the description below, in the claims below, and in the accompanying drawings, the term “substantially parallel” means two linear elements are mostly, even if not completely, the same distance apart at every corresponding point. For instance, an average length measured may be considered substantially parallel to a direction of an approaching motor vehicle if the angle between the average length measured and the direction of the approaching motor vehicle is 30 degrees or less.

As used in this summary, in the description below, in the claims below, and in the accompanying drawings, the term “algorithm” means a set of rules designed to perform a task, for instance, a set of rules used by a computer or a processor to perform a task. An algorithm may be configured to run on software, hardware or a combination of software and hardware. Hence, a vehicular control assistance function algorithm is a set of rules designed to perform a task designed to help or support a driver or a driving system to drive a vehicle.

As used in this summary, in the description below, in the claims below, and in the accompanying drawings, the term “volatile memory” means any type of computer memory where the contents of the memory are lost if there is no power to the computer. Random-access memory (RAM) is an example of a type of volatile memory. As used in the summary above, in this description, in the claims below, and in the accompanying drawings, the term “nonvolatile memory” or the term “non-transitory computer-readable medium” means any type of computer memory where the contents of the memory are retained even if there is no power to the computer. Hard disk and solid-state drive (SSD) are examples of types of nonvolatile memory or non-transitory computer-readable medium.

As used in this summary, in the description below, in the claims below, and in the accompanying drawings, the term “processor” means a computer component that is configured to perform calculations, make decisions, execute instructions, process data or control other computer components. Central processing unit (CPU) and graphics processing unit (GPU) are examples of types of processor.

### BRIEF DESCRIPTION OF THE DRAWINGS

These and other features, aspects, and advantages will become better understood with regard to the following description, appended claims, and accompanying drawings where:

FIG. 1 shows a spike barrier detection vehicular system;

FIG. 2 shows a spike barrier;

FIG. 3 shows a motor vehicle comprising the spike barrier detection vehicular system of FIG. 1; and

FIG. 4 shows a diagram for a spike barrier detection vehicular method.

In the drawings, like parts are denoted by like reference numerals.

### DETAILED DESCRIPTION

In the summary above, in this description, in the claims below, and in the accompanying drawings, reference is made to particular features (including method steps) of the disclosure. It is to be understood that the disclosure in this specification includes all possible combinations of such particular features. For example, where a particular feature is disclosed in the context of a particular aspect or embodiment of the disclosure, or a particular claim, that feature may also be used, to the extent possible, in combination with and/or in the context of other particular aspects and embodiments of the disclosure, and in the disclosures generally.

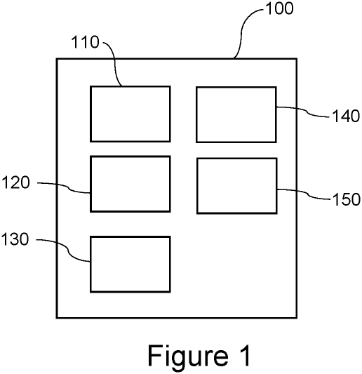

FIG. 1 shows a spike barrier detection vehicular system 100 that may include an image receiver 110, a vehicular plan image constructor 120, a spike barrier detector 130, a length determiner 140 and a vehicular approach prevention direction determiner 150. The spike barrier detection vehicular system 100 may comprise hardware, such as at least one processor, volatile memory or/and nonvolatile memory, software comprising instructions executable by a processor, or a combination of software and hardware.

The image receiver 110 may be configured to receive an image, for instance, a vehicular image from captured by a vehicular camera. The image receiver 110 may also be configured to receive at least two images from a plurality of imaging devices, each image from a respective imaging device. For example, the image receiver 110 may receive at least two vehicular images from at least two vehicular cameras, for instance, a front camera and a rear camera. The image receiver 110 may comprise hardware, such as at least one processor, volatile memory or/and nonvolatile memory, software comprising instructions executable by a processor, or a combination of software and hardware.

The vehicular plan image constructor 120 is configured to construct a vehicular plan view image based on an image received by the image receiver 110. The vehicular plan image constructor 120 may be configured to construct a vehicular plan view image based on at least two images received by the image receiver 110. The vehicular plan image constructor 120 may comprise a geometric projection algorithm configured to construct the vehicular plan view image. For instance, the vehicular plan image constructor 120 may comprise a geometric projection algorithm configured to convert an image comprising a side view of a spike barrier into another image comprising a plan view of the spike barrier. The vehicular plan image constructor 120 may comprise hardware, such as at least one processor, volatile memory or/and nonvolatile memory, software comprising instructions executable by a processor, or a combination of software and hardware.

The spike barrier detector 130 may be configured to detect a spike barrier from an image received by the image receiver 110. The spike barrier detector 130 may also be configured to detect a spike barrier from a vehicular plan view image. The spike barrier detector 130 may comprise a machine learning system trained to recognise a spike barrier. The spike barrier detector 130 may also comprise a neural network trained to recognise a spike barrier. The spike barrier detector 130 may comprise hardware, such as at least one processor, volatile memory or/and nonvolatile memory, software comprising instructions executable by a processor, or a combination of software and hardware.

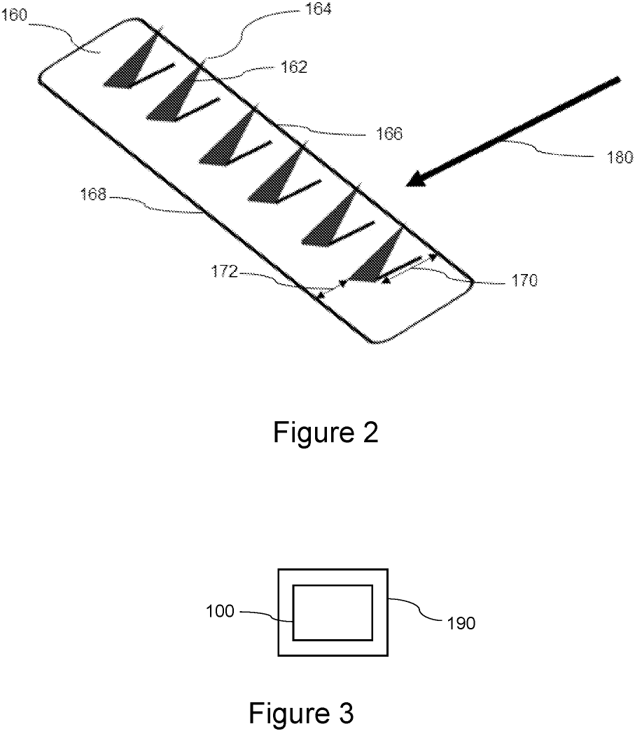

FIG. 2 shows a spike barrier 160 comprising vehicular immobility projections 162 arranged in a row, wherein each vehicular immobility projection 162 comprises a respective converging end 164 configured to puncture a tyre, for instance, a motor vehicle tyre. The spike barrier 160 comprises a first edge 166 substantially parallel to the row of vehicular immobility projections 162 and proximate the converging ends 164, and a second edge 168 opposite the first edge 166 and remote from the converging ends 164. The spike barrier 160 may be configured such that its vehicular approach prevention direction 180 is towards the first edge 166 of the spike barrier 160.

The length determiner 140 may be configured to determine a first average length 170 between at least two vehicular immobility projections 162 and a first edge 166 of a spike barrier 160 based on an image received from the image receiver 110, and a second average length 172 between the at least two vehicular immobility projections 162 and a second edge 168 of the spike barrier 160 based on the image received from the image receiver 110, wherein the first average length 170 determined is substantially parallel to a vehicular approach prevention direction 180 and the second average length 172 determined is substantially parallel to the vehicular approach prevention direction 180. The length determiner 140 may also be configured to determine a first average length 170 between at least two vehicular immobility projections 162 and a first edge 166 of a spike barrier 160 based on a vehicular plan view image, and a second average length 172 between the at least two vehicular immobility projections 162 and a second edge 168 of the spike barrier 160 based on the vehicular plan view image, wherein the first average length 170 determined is substantially parallel to a vehicular approach prevention direction 180 and the second average length 172 determined is substantially parallel to the vehicular approach prevention direction 180. The length determiner 140 may comprise hardware, such as at least one processor, volatile memory or/and nonvolatile memory, software comprising instructions executable by a processor, or a combination of software and hardware.

The vehicular approach prevention direction determiner 150 may be configured to determine a vehicular approach prevention direction 180 of a spike barrier 160 based on an image received from the imaged receiver 110. The vehicular approach prevention direction determiner 150 may be configured to determine a vehicular approach prevention direction 180 of a spike barrier 160 based a vehicular plan view image.

The vehicular approach prevention direction determiner 150 may be configured to determine that a vehicular approach prevention direction 180 of a spike barrier 160 is towards a first edge 166 of the spike barrier 166 if a first average length 170 is longer than a second average length 170. The vehicular approach prevention direction determiner 150 may also be configured to determine that converging ends 164 are orientated towards a first edge 166 of a spike barrier 160 if a first average length 170 is longer than the second average length 172. The vehicular approach prevention direction determiner 150 may comprise hardware, such as at least one processor, volatile memory or/and nonvolatile memory, software comprising instructions executable by a processor, or a combination of software and hardware.

FIG. 3 shows a motor vehicle 190 comprising the spike barrier detection vehicular system 100. The motor vehicle 190 may be a car.

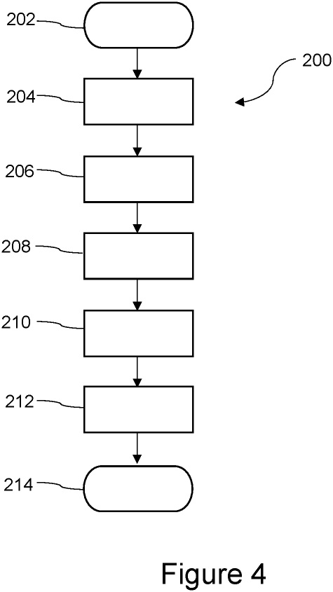

FIG. 4 shows a diagram for a spike barrier detection vehicular method 200 using the spike barrier detection vehicular system 100. The steps or acts of the spike barrier detection vehicular method 200 may be performed by at least one processor, for instance, by the at least one processor executing instructions stored on at least one non-transitory computer-readable medium.

At step 202, the spike barrier detection vehicular method 200 begins, for example, when a motor vehicle 160 is started. Then at step 204, at least one image, for instance, a vehicular image from a vehicular camera, is received by the image receiver 110. Optionally, at step 206, a vehicular plan view image is constructed by the vehicular plan image constructor 120 based on the at least one image received by the image receiver 110.

At step 208, a spike barrier 160 comprised in the vehicular plan view image or the at least one image is detected or recognised by the spike barrier detector 130. Subsequently, at step 210, a first average length 170 between at least two vehicular immobility projections 162 and a first edge 166 of the spike barrier 160 is determined by the length determiner 140, and a second average length 172 between the at least two vehicular immobility projections 162 and a second edge 168 of the spike barrier 160 is determined by the length determiner 140, wherein the first average length 170 determined and the second average length 172 determined are substantially parallel to a vehicular approach prevention direction 180.

Thereafter, at step 212, the vehicular approach prevention direction 180 is determined by determining whether the first average length 170 or the second average length 172 is longer, by the vehicular approach prevention direction determiner 150.

Finally, at step 214, the spike barrier detection vehicular method 200 ends, for example, when the ignition is turned off.

Although the invention has been described in considerable detail with reference to certain embodiments or aspects, other embodiments or aspects are possible.

For example, an additional step of alerting a driver of the motor vehicle 190, may be included after step 212, if the motor vehicle 190 approaches the spike barrier 160 in the vehicular approach prevention direction 180.

Therefore, the spirit and scope of the appended claims should not be limited to the description of the embodiments contained herein.

All features disclosed in this specification (including the appended claims, abstract, and accompanying drawings) may be replaced by alternative features serving the same, equivalent, or similar purpose, unless expressly stated otherwise. Thus, unless expressly stated otherwise, each feature disclosed is one example only of a generic series of equivalent or similar features.

1. A spike barrier detection vehicular system comprising:
an image receiver configured to receive an image comprising a spike barrier; and
a vehicular approach prevention direction determiner configured to determine a vehicular approach prevention direction of the spike barrier, based on the image comprising the spike barrier.

2. The spike barrier detection vehicular system as in claim 1, wherein the image receiver is configured to receive at least two images from a plurality of imaging devices, each image from a respective imaging device.

3. The spike barrier detection vehicular system as in claim 2, further comprising:
a vehicular plan image constructor configured to construct a vehicular plan view image comprising the spike barrier based on the image comprising the spike barrier;
wherein the vehicular approach prevention direction determiner is configured to determine the vehicular approach prevention direction of the spike barrier, based on the vehicular plan view image comprising the spike barrier.

4. The spike barrier detection vehicular system as in claim 3,
wherein the spike barrier comprises at least two vehicular immobility projections;
further comprising a length determiner configured to determine a first average length between the at least two vehicular immobility projections and a first edge of the spike barrier based on the vehicular plan view image comprising the spike barrier and a second average length between the at least two vehicular immobility projections and a second edge of the spike barrier based on the vehicular plan view image comprising the spike barrier;
wherein the first average length determined is substantially parallel to the vehicular approach prevention direction and the second average length determined is substantially parallel to the vehicular approach prevention direction.

5. The spike barrier detection vehicular system as in claim 1,
wherein the spike barrier comprises at least two vehicular immobility projections;
further comprising a length determiner configured to determine a first average length between the at least two vehicular immobility projections and a first edge of the spike barrier and a second average length between the at least two vehicular immobility projections and a second edge of the spike barrier;
wherein the first average length determined is substantially parallel to the vehicular approach prevention direction and the second average length determined is substantially parallel to the vehicular approach prevention direction.

6. The spike barrier detection vehicular system as in claim 4, wherein the vehicular approach prevention direction determiner is configured to determine that the vehicular approach prevention direction of the spike barrier is towards the first edge of the spike barrier if the first average length is longer than the second average length and that the vehicular approach prevention direction of the spike barrier is towards the second edge of 15 the spike barrier if the second average length is longer than the first average length.

7. The spike barrier detection vehicular system as in claim 4,
wherein each vehicular immobility projection comprises a respective converging end configured to puncture a tyre; and
wherein the vehicular approach prevention direction determiner is configured to determine that the converging ends are orientated towards the first edge of the spike barrier if the first average length is longer than the second average length and that the converging ends are orientated towards the second edge of the spike barrier if the second average length is longer than the first average length.

8. A spike barrier detection vehicular system comprising:
an image receiver configured to receive an image comprising a spike barrier, wherein the spike barrier comprises at least two vehicular immobility projections;
wherein the image receiver is configured to receive at least two images from a plurality of imaging devices, each image from a respective imaging device;
a vehicular plan image constructor configured to construct a vehicular plan view image comprising the spike barrier based on the image comprising the spike barrier;
a length determiner configured to determine a first average length between the at least two vehicular immobility projections and a first edge of the spike barrier based on the vehicular plan view image comprising the spike barrier and a second average length between the at least two vehicular immobility projections and a second edge of the spike barrier based on the vehicular plan view image comprising the spike barrier;
wherein the first average length determined is substantially parallel to the vehicular approach prevention direction and the second average length determined is substantially parallel to the vehicular approach prevention direction; and
a vehicular approach prevention direction determiner configured to determine a vehicular approach prevention direction of the spike barrier, based on the image comprising the spike barrier;
wherein the vehicular approach prevention direction determiner is configured to determine the vehicular approach prevention direction of the spike barrier, based on the vehicular plan view image comprising the spike barrier;
wherein the vehicular approach prevention direction determiner is configured to determine that the vehicular approach prevention direction of the spike barrier is towards the first edge of the spike barrier if the first average length is longer than the second average length and that the vehicular approach prevention direction of the spike barrier is towards the second edge of the spike barrier if the second average length is longer than the first average length;
wherein each vehicular immobility projection comprises a respective converging end configured to puncture a tyre; and
wherein the vehicular approach prevention direction determiner is configured to determine that the converging ends are orientated towards the first edge of the spike barrier if the first average length is longer than the second average length and that the converging ends are orientated towards the second edge of the spike barrier if the second average length is longer than the first average length.

9. A computer-implemented spike barrier detection vehicular method comprising:
receiving an image comprising a spike barrier; and
determining a vehicular approach prevention direction of the spike barrier, based on the image comprising the spike barrier.

10. The computer-implemented spike barrier detection vehicular method as set forth in claim 9, further comprising receiving at least two images from a plurality of imaging devices, each image from a respective imaging device.

11. The computer-implemented spike barrier detection vehicular method as set forth in claim 10, further comprising:
constructing a vehicular plan view image comprising the spike barrier based on the image comprising the spike barrier;
wherein the act of determining the vehicular approach prevention direction of the spike barrier comprises the act of determining the vehicular approach prevention direction of the spike barrier, based on the vehicular plan view image comprising the spike barrier.

12. The computer-implemented spike barrier detection vehicular method as set forth in claim 11,
wherein the act of receiving the image comprising the spike barrier comprises the act of receiving the image comprising the spike barrier, wherein the spike barrier comprises at least two vehicular immobility projections;
the method further comprising:
determining a first average length between the at least two vehicular immobility projections and a first edge of the spike barrier based on the vehicular plan view image comprising the spike barrier, wherein the first average length determined is substantially parallel to the vehicular approach prevention direction; and
determining a second average length between the at least two vehicular immobility projections and a second edge of the spike barrier based on the vehicular plan view image comprising the spike barrier, wherein the second average length determined is substantially parallel to the vehicular approach prevention direction.

13. The computer-implemented spike barrier detection vehicular method as set forth in claim 12,
wherein the act of receiving the image comprising the spike barrier comprises the act of receiving the image comprising the spike barrier, wherein the spike barrier comprises at least two vehicular immobility projections;
further comprising:
determining a first average length between the at least two vehicular immobility projections and a first edge of the spike barrier, wherein the first average length determined is substantially parallel to the vehicular approach prevention direction; and
determining a second average length between the at least two vehicular immobility projections and a second edge of the spike barrier, wherein the second average length determined is substantially parallel to the vehicular approach prevention direction.

14. The computer-implemented spike barrier detection vehicular method as set forth in claim 12, wherein determining the vehicular approach prevention direction of the spike barrier comprises determining that the vehicular approach prevention direction of the spike barrier is towards the first edge of the spike barrier if the first average length is longer than the second average length and that the vehicular approach prevention direction of the spike barrier is towards the second edge of the spike barrier if the second average length is longer than the first average length.

15. The computer-implemented spike barrier detection vehicular method as set forth in claim 12:
wherein receiving the image comprising the spike barrier comprises receiving the image comprising the spike barrier, wherein each vehicular immobility projection comprises a respective converging end configured to puncture a tyre; and
wherein determining the vehicular approach prevention direction of the spike barrier comprises the act of determining that the converging ends are orientated towards the first edge of the spike barrier if the first average length is longer than the second average length and that the converging ends are orientated towards the second edge of the spike barrier if the second average length is longer than the first average length.
